(19) United States
(12) Patent Application Publication
(10) Pub. No.: US 2026/0287131 A1
(43) Pub. Date: Sep. 24, 2026

(54) Lighting tube for refrigerator

(71) Applicant: ENERGYLED ELECTRONICS CORPORATION, Zhaoqing City (CN)

(72) Inventors: Deliang XIAO, Zhaoqing City (CN); Zixiang XIAO, Zhaoqing City (CN); Qing MA, Zhaoqing City (CN); Kegang YUE, Zhaoqing City (CN); Chao Hsien WU, Zhaoqing City (CN)

(21) Appl. No.: 19/438,375

(22) Filed: Dec. 31, 2025

(30) Foreign Application Priority Data
Mar. 24, 2025 (CN) 202520526715.4

(51) Int. Cl. F21S 4/28; F25D 27/00; F21W 131/305; F21Y 115/10

(52) U.S. Cl. CPC F21S 4/28; F25D 27/00; F21W 2131/305; F21Y 2115/10

(57) ABSTRACT

A lighting tube for a refrigerator includes a base; an LED light source module; a power supply component electrically connected to the LED light source module, where the LED light source module and the power supply component are disposed inside the base; and a lens disposed in a light-emitting direction of the LED light source module and mounted to the base, where the lens has a cross section in form of an inverted V-shaped structure, which is configured to transmit a central light beam emitted by the LED light source module to outside along the two sides of the inverted V-shaped structure.

### CROSS REFERENCE TO RELATED APPLICATIONS

The present application claims priority from Chinese Application No. CN 202520526715.4 filed on Mar. 24, 2025, all of which are hereby incorporated herein by reference.

### TECHNICAL FIELD

The present disclosure relates to the technical field of lighting fixtures, and in particular, to a lighting tube for a refrigerator.

### BACKGROUND

With rapid development of the retail industry, malls and supermarkets have increasingly higher requirements for commodities display effects. In the fields of cold chain logistics and food preservation, refrigerators are key equipment for storing and displaying commodities such as frozen foods, beverages and ice creams. However, in the current lighting application for supermarket refrigerators, effective illumination intensity per area is relatively low, which fails to highlight the lighting effect. Moreover, the current lighting tube requires numerous additional components, leading to complex manufacturing processes, unsatisfactory sealing performance, and high production cost. In addition, due to uneven refraction or reflection of light at connection points of the current lighting tube, the light distribution in the illumination area becomes uneven, causing irregular yellow lines or shadows in the refrigerator. This not only affects the lighting effect, but may also impair the display effect of commodities.

Therefore, it is desirable to propose an improved lighting tube for a refrigerator with a reasonable optical design for a lighting tube structure and a light source position.

### SUMMARY

One aspect of the present disclosure provides a lighting tube for a refrigerator, including a base; an LED light source module; a power supply component electrically connected to the LED light source module, where the LED light source module and the power supply component are disposed inside the base; and a lens disposed in a light-emitting direction of the LED light source module and mounted to the base, where the lens has a cross section in form of an inverted V-shaped structure, which is configured to transmit a central light beam emitted by the LED light source module to outside along the two sides of the inverted V-shaped structure.

Second aspect of the present disclosure provides a refrigerator, including a refrigerator body; at least one shelf optionally provided inside the refrigerator body; and the lighting tube for illuminating the inner side of the refrigerator body.

Third aspect of the present disclosure provides a method of use of the lighting tube, including fixing the lighting tube to a light fixture inside of a refrigerator in a wall-mounted or built-in manner.

### BRIEF DESCRIPTION OF THE DRAWINGS

FIG. 1 is a sectional view of a lighting tube with single-sided light-emitting effect according to an embodiment of the present disclosure;

FIG. 2 is a sectional view of a lens according to an embodiment of the present disclosure;

FIG. 3 is a sectional view of a lighting tube with double-sided light-emitting effect according to an embodiment of the present disclosure;

FIG. 4 is a schematic view of an LED light source module along the length direction of the lighting tube; and

FIG. 5 is a schematic view showing a lighting tube in use according to the present disclosure.

### DETAILED DESCRIPTION OF THE EMBODIMENTS

The accompanying drawings of the present disclosure are only used for illustration, and should not be construed as limitations to the present disclosure. In order to better illustrate the following embodiments, some components in the accompanying drawings may be omitted, enlarged or reduced, and this does not represent the actual size of a product. It can be understood by those skilled in the art that some well-known structures and their illustrations might be omitted in the accompanying drawings.

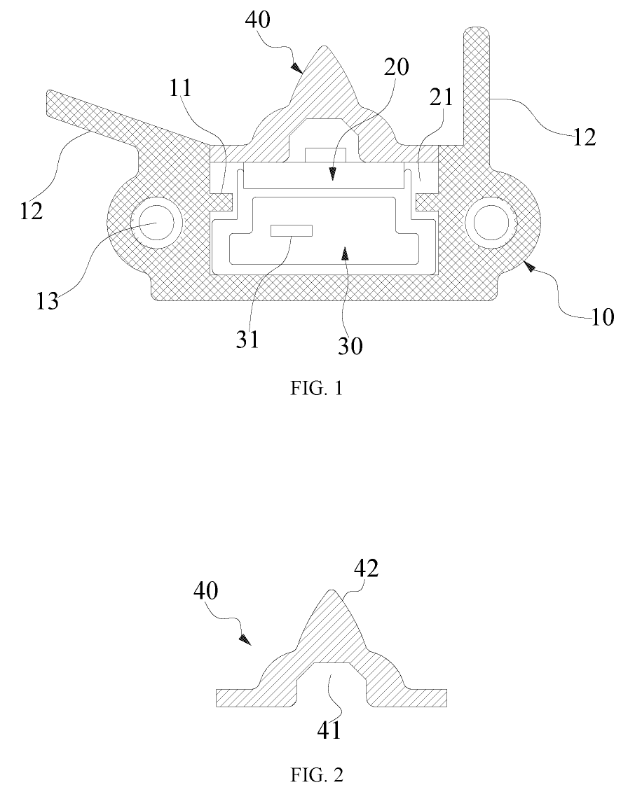

FIG. 1 shows a sectional view of a lighting tube for a refrigerator with single-side light emitting effect according to an embodiment of the present disclosure. The lighting tube in the present embodiment includes a base 10, an LED light source module 20, a power supply component 30, and a lens 40. The LED light source module 20 and the power supply component 30 are electrically connected each other and disposed inside the base 10. The lens 40 is disposed in a light-emitting direction of the LED light source module 20 and is mounted to the base 10. The lens 40 in this embodiment has a cross section in form of an inverted V-shaped structure, which is configured to transmit a central light beam emitted by the LED light source module 20 to the outside along the two sides of the inverted V-shaped structure, especially in left and right directions of the inverted V-shaped structure in the present embodiment. That is, the light beam has been expanded by the inverted V-shaped lens 40.

In this embodiment, a reasonable optical structure is obtained by forming the lens 40 into an inverted V-shaped structure and providing the lens 40 in the light-emitting direction of the LED light source module 20, which splits the light beam emitted by the LED light source module 20 into two different directions for transmitting. In such way of changing the lighting tube structure and the emitting position of the light source, the effective illumination intensity per area is effectively increased, with the illumination uniformity reaching 80% or above. Therefore, the lighting effect is improved.

Referring to FIG. 2, the inverted V-shaped structure of the lens 40 particularly includes a recessed portion 41 and an elongated protruding portion 42. The recessed portion 41 is disposed directly above the light outlet of the LED light source module 20 to distribute the light beam emitted by the LED light source module 20. The elongated protruding portion 42 is disposed at the top of the lens and has an arc outer surface for improving the light-emitting efficiency.

In the lens 40 of the present embodiment, the recessed portion 41 disposed directly above the light outlet of the LED light source module 20 can directly distribute the light beam with higher light intensity from the LED light source module 20. Then the light beam is transmitted to the outside from the arc outer surface of the elongated protruding portion 42. In such way, the optical transmittance of the lighting tube is effectively increased. Especially, when the light beam is perpendicular to the light-emitting surface, the light-emitting efficiency is maximized. With this configuration, the light beam emitted by the LED light source module 20 vertically enters the lens 40 through the recessed portion 41, then perpendicularly exits through the arc outer surface of the lens 40, and diverges outward in an expanded direction. This result in more uniform light diffusion and ensures that the light beam from the LED light source module 20 are all emitted outward, thereby improving the light-emitting efficiency.

Preferably, in order to improve the optical performance of the lens 40, the lens 40 in the present embodiment is made of transparent material combined with diffuse scattering powder.

In this embodiment, the transparent material used for the lens 40 of the lighting tube is usually high-quality plastic, which can effectively enhance the light transmittance. The transparent material helps reduce light loss and ensures effective transmitting of the light, thus improving the overall light effect of the lighting tube. Therefore, such design can ensure higher light output without increasing energy consumption.

In addition, in the lighting tube structure, due to the possibility of seams or uneven light distribution at junctions of components during manufacturing process of the lighting tube, noticeable yellow lines or bright spots may be caused, which affects the uniformity of illumination. To eliminate these uneven lighting effects, the diffuse scattering powder is usually added to the lens 40. The light can be scattered by the scattering powder when passing through the lens 40, thereby eliminating the bright spots at the seams or junctions to obtain a more uniform light distribution. In this way, the yellow line can be eliminated, making the lighting effect softer and more uniform, thus enhancing visual experience.

The base 10 in this embodiment is of a U-shaped structure. Protrusions 11 are inwardly formed at both sides. In this situation, clamping grooves 21 are defined between the protrusions 11 and the lens 40 disposed above. The LED light source module 20 is snap-fitted onto the clamping grooves 21.

Through the clamping grooves 21 formed between the protrusions 11 and the lens 40, the LED light source module 20 can be firmly fixed to the base 10, preventing the module 20 from loosening or moving due to vibration or an external force, thereby ensuring stability and long-term operation reliability of the LED light source. Moreover, such design of the clamping grooves 21 can also simplify the assembly of the LED light source module 20. Since the LED light source module 20 can be easily snap-fitted onto the clamping grooves 21, complex fixing process can be eliminated, thus improving the production and installation efficiency thereof. In addition, fixing the LED light source module 20 in the clamping grooves 21 also helps assembly of the lens 40, which can achieve accurate alignment between the LED light source and the lens 40. The accurate alignment aids in accurate propagation of light, thereby avoiding light displacement or distortion caused by misalignment between the light source and the lens 40, further improving uniformity and quality of the light effect, and avoiding light spots or uneven illumination.

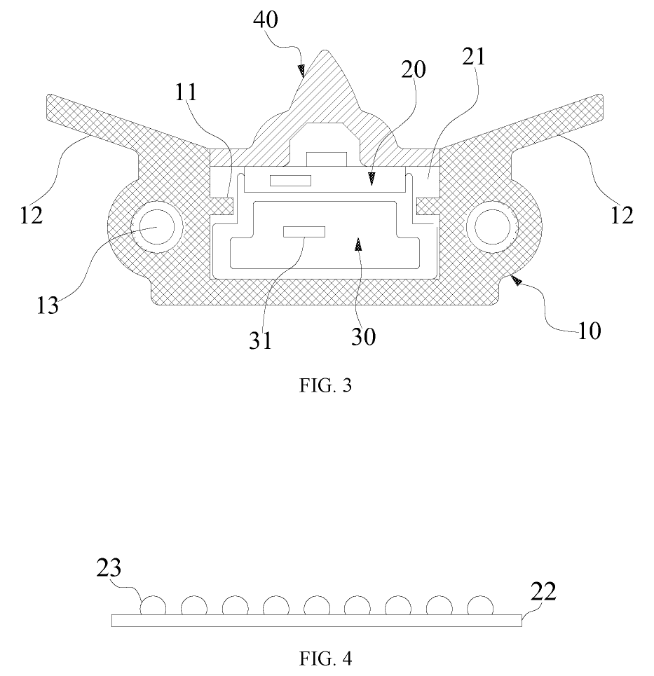

Preferably, the base 10 is white. Baffles 12 are formed at both sides of the top of the base 10. A single-sided light-emitting effect is formed in a case that the baffle 12 at one side is extended vertically upward and the baffle 12 at the other side is extended outward, as shown in FIG. 1; and a double-sided light-emitting effect is formed in a case that the baffles 12 at the both sides are extended outward, as shown in FIG. 3.

The white base 10 can effectively perform diffuse reflection to reflect more light, which helps to evenly distribute the light and provides softer light. This improves the overall light effect and ensures that more light can be effectively utilized, thereby improving the brightness of illumination. The white surface can reflect most of the light and also heat to reduce the heat absorbed by the base 10, which is advantageous for heat dissipation, so that the LED light source is prevented from lower efficiency or short service life due to overheating. In addition, the base 10 with different baffles 12 can be selected to control the light-emitting angle and light effect, thereby effectively improving the illumination intensity per area of the lighting tube.

The lighting tube is preferably integrally formed by an aluminium extrusion embedding technology.

Such process method can effectively improve strength of the lighting tube. The aluminium alloy has excellent thermal conductivity, so that in electronic or lighting products the aluminium extrusion embedding technology can significantly improve heat dissipation efficiency to reduce operating temperature of the lighting tube, and also prolong service life of the product. Additionally, integral design can hide the seams or reduce the visible junctions to improve sealing performance of the lighting tube, which allows the lighting tube to be suitable for humid environments, such as refrigerators.

Referring to FIG. 4, the LED light source module 20 particularly includes a light strip 22 with heat-dissipation circuit and a plurality of light beads 23. The light beads 23 are evenly distributed along a central line of the light strip 22, and both sides of the light strip 22 are snap-fitted onto the clamping grooves 21.

The light strip 22, due to its better flexibility, can be easily installed in the clamping grooves 21. In addition, the light strip 22 having heat-dissipation circuit generates less heat, which thus prolongs the service life of the lighting tube. Moreover, the plurality of light beads 23 evenly distributed on the light strip allows the light emitted from the lighting tube more uniform and softer, thereby further improving the light effect. The light strip 22 especially has a waterproof design, such as IP65 or higher waterproof rating, making it suitable for applications in outdoor or humid environments, such as refrigerators and other storage environments.

Power sockets 13 are formed in both sides of the base 10 for power supply connection, when mounted the lighting tube in a lighting fixture, such as inside the refrigerator.

The power socket 13 can simplify the connection between the lighting tube and the lighting fixture inside the refrigerator. Therefore, power connection can be achieved only by inserting the lighting tube into the socket 13, which reduces complexity of traditional wiring, and thus improves installation efficiency. Moreover, the socket design eliminates bare wires to prevent the wires from being exposed externally, thereby effectively reducing the risk of electric shock or short circuit of the power supply in a humid environment of the refrigerator. In the present disclosure, by fixing the position of the power socket 13 for power connection, the connection is more stable and secure. In addition, the power socket 13 can also ensure that the lighting tube can be stably powered when installed in the lighting fixture of the refrigerator, avoiding malfunction of the lighting tube due to unsatisfactory contact, thereby improving reliability and long-term use effect of the equipment.

The power supply component 30 in the present embodiment may particularly include an overvoltage and overcurrent protection unit 31 to prevent damage to the lighting tube caused by circuit failure.

FIG. 3 shows a sectional view of a lighting tube for a refrigerator with double-side light emitting effect according to an embodiment of the present disclosure. In this embodiment, the baffles 12 of the base 10 at the both sides are all extended outward.

In an alternative embodiment, the baffles 12 can be rotated relative to the base 10. Especially, the baffles 12 in this embodiment can be rotated to any angles relative to the base 10 according to actual demands.

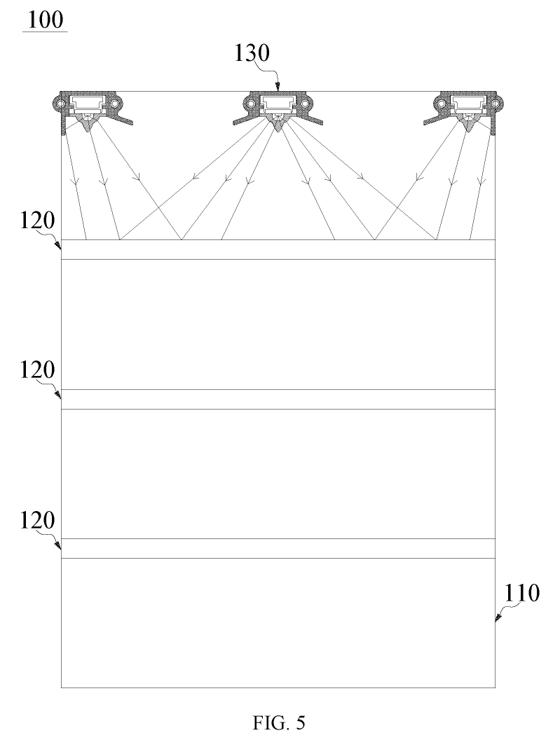

FIG. 5 depicts a schematic diagram of a refrigerator 100. The refrigerator 100 in this embodiment includes a refrigerator body 110, shelves 120 optionally provided inside the refrigerator 110, and a lighting tube 130 mentioned above fixed inside the refrigerator 110 for illuminating the inner side of the refrigerator body 110. The lighting tube 130 can be mounted in a lighting fixture inside a refrigerator body 110 in a wall-mounted or built-in manner. Particularly, the lighting tube 130 can be arranged in the middle portion of the top of the refrigerator body 110. The lighting tube 130 can also be arranged in the side portion of the top of the refrigerator body 110. As an example, the refrigerator 100 as illustrated in FIG. 5 includes three lighting tubes 130, one arranged in the middle portion, and two respectively arranged in each side portion.

As shown, when disposed close to the side portion of the refrigerator body 110, the lighting tube 130 provides a single-sided light-emitting effect, with one baffle 12 extended vertically upward and the other baffle 12 extended outward, as shown in FIG. 1. The baffle 12 extended vertically upward in this embodiment is fitted against the inner wall of the refrigerator body 110. In this situation, the light close to the baffle 12 extended vertically upward is reflected by such baffle 12 to change the transmitting path and finally transmitted to the center of the refrigerator body 110. While the light close to the center of the refrigerator body 110 is directly transmitted to the the center of the refrigerator body 110.

When disposed in the middle portion of the refrigerator body 110, the lighting tube 130 provides a double-sided light-emitting effect, with both two baffles 30 both extended outward, as shown in FIG. 3, which allows light to be emitted around the refrigerator body 110 and evenly dispersed to the center and surrounding areas of the refrigerator body 110.

In such configuration, the light emitted from the lighting tube can cover the entire interior of the refrigerator body 110, thereby effectively increasing the illumination intensity per area and thus improving the whole light effect.

Especially, the lighting tube with double-sided light-emitting effect is disposed at a middle point between the two lighting tubes with single-sided light-emitting effect.

While preferred embodiments have been shown and described, various modifications and substitutions may be made thereto without departing from the spirit and scope of the disclosure. Accordingly, it is to be understood that the present disclosure has been described by way of illustration and not limitation.

What is claimed is:

1. A lighting tube for a refrigerator, comprising:
a base;
an LED light source module;
a power supply component electrically connected to the LED light source module, wherein the LED light source module and the power supply component are disposed inside the base; and
a lens disposed in a light-emitting direction of the LED light source module and mounted to the base, wherein the lens has a cross section in form of an inverted V-shaped structure, which is configured to transmit a central light beam emitted by the LED light source module to outside along two sides of the inverted V-shaped structure.

2. The lighting tube according to claim 1, the inverted V-shaped structure of the lens comprises:
a recessed portion disposed above the LED light source module, which is configured to distribute the light beam form the LED light source module; and
an elongated protruding portion disposed at a top portion of the lens, which has an arc outer surface.

3. The lighting tube according to claim 1, wherein the lens is made of transparent material combined with diffuse scattering powder.

4. The lighting tube according to claim 1, wherein the base is of a U-shaped structure with protrusions inwardly formed at both sides, clamping grooves are formed between the protrusions and the lens, and the LED light source module is snap-fitted onto the clamping grooves.

5. The lighting tube according to claim 4, wherein a baffle is formed at a top portion of each side of the base, with the baffle at each side extended outward.

6. The lighting tube according to claim 4, wherein a baffle is formed at a top portion of each side of the base, with the baffle at one side of the base extended vertically upward and the baffle at the other side of the base extended outward.

7. The lighting tube according to claim 4, wherein a baffle is formed at a top portion of each side of the base, wherein the baffle in at least one side of the base is rotatable relative to the base.

8. The lighting tube according to claim 4, wherein the LED light source module comprises a light strip with a heat-dissipation circuit and a plurality of light beads evenly distributed along the light strip, and both sides of the light strip are correspondingly snap-fitted onto the clamping grooves.

9. The lighting tube according to claim 1, wherein the base is formed with power sockets for power supply connection.

10. The lighting tube according to claim 1, wherein the power supply component comprises an overvoltage and overcurrent protection unit to prevent damage caused by circuit failure.

11. A refrigerator, comprising a refrigerator body; at least one shelf optionally provided inside the refrigerator body; and a lighting tube according to claim 1 for illuminating an inner side of the refrigerator body.

12. The refrigerator according to claim 11, wherein the lighting tube having a baffle formed at a top portion of each side of the base is disposed at a middle portion of a top of the refrigerator body, with the baffle at each side extended outward.

13. The refrigerator according to claim 11, wherein the lighting tube having a baffle formed at a top portion of each side of the base is disposed at a side portion of a top of the refrigerator body, with the baffle at one side of the base extended vertically upward and the baffle at the other side of the base extended outward

14. The refrigerator according to claim 11, wherein the inverted V-shaped structure of the lens comprises:
a recessed portion disposed above the LED light source module, which is configured to distribute the light beam form the LED light source module; and
an elongated protruding portion disposed at a top portion of the lens, which has an arc outer surface.

15. The refrigerator according to claim 11, wherein the base is of a U-shaped structure with protrusions inwardly formed at both sides, clamping grooves are formed between the protrusions and the lens, and the LED light source module is snap-fitted onto the clamping grooves.

16. A method of use of the lighting tube according to claim 1, comprising fixing the lighting tube to a light fixture inside of a refrigerator in a wall-mounted or built-in manner.

17. The method according to claim 16, wherein the lighting tube having a baffle formed at a top portion of each side of the base is fixed to a middle portion of a top of the refrigerator body, with the baffle at each side extended outward.

18. The method according to claim 16, wherein the lighting tube having a baffle formed at a top portion of each side of the base is fixed to a side portion of a top of the refrigerator body, with the baffle at one side of the base extended vertically upward and the baffle at the other side of the base extended outward.
